(19) United States
(12) Patent Application Publication
(10) Pub. No.: US 2012/0239512 A1
(43) Pub. Date: Sep. 20, 2012

(54) MOBILE PROXIMITY BASED RETAIL MARKETING SYSTEM

(76) Inventor: Randy MERSKY, Silver Spring, MD (US)

(21) Appl. No.: 13/048,087

(22) Filed: Mar. 15, 2011

(51) Int. Cl. G06Q 30/00

(52) U.S. Cl. 705/14.73; 705/1.1; 705/14.4

(57) ABSTRACT

A system, method, device, and non-transitory computer-readable medium for providing an incentive to a user of a device to monitor information displayed on a display of the device are provided. The information is visibly displayed on the display of the device. A physical relationship between the device that includes the display that displays the information and the user is monitored while the information is displayed on the display. A reward that is based on the physical relationship that is monitored between the device and the user is displayed on the display of the device.

### BACKGROUND

1. Field of the Disclosure

The present disclose generally relates to the fields of marketing and advertising. More particularly, the present disclosure relates to incentivizing interaction with marketing and advertising materials.

2. Background Information

Traditionally, marketing and advertising materials were generally provided to consumers via print media, such as magazines and newspapers. Over the years, marketing and advertising materials were integrated into electronic forms of media, such as televisions, radios, and the world wide web. Consumers were typically stationary when viewing such print and electronic forms of media and often devoted the majority of their attention thereto. As a result, marketers and advertisers were not significantly tasked with maintaining the consumers' attention.

Marketers and advertisers, however, are constantly looking for new methods of reaching consumers. As a result, marketers and advertisers have recently begun to provide marketing and advertising materials to consumers via mobile devices, such as cellular telephones and personal data assistants. Consumers generally view such devices while on-the-go and devote less than their entire attention to these devices. As a result, marketers and advertisers are tasked with finding new ways of maintaining consumers' attention.

### SUMMARY OF THE DISCLOSURE

In view of the foregoing, the present disclosure, through one or more of its various aspects, embodiments, and/or specific features or sub-components, provides an incentive to a user of a device to monitor information displayed on a display of the device. According to the present disclosure, an interaction between the user and the device on which the information is displayed may be monitored, and a reward may be provided to the user in correspondence with the monitored interaction. As such, the user is provided with an incentive, such as a reward, to interact with the device on which the information is displayed, thereby increasing and maintaining the user's attention toward the device and the information displayed thereon. As a result, the impact and effect of the information on the user is enhanced via the increased attention.

According to a non-limiting embodiment of the present disclosure, at least one non-transitory computer-readable medium provides an incentive to a user of a device to monitor information displayed on a display of the device. The at least one non-transitory computer-readable medium includes a displaying code segment that, when executed, visibly displays the information on the display of the device. A monitoring code segment, when executed, monitors a physical relationship between the device that includes the display that displays the information and the user while the displaying code segment displays the information. A reward displaying code segment, when executed, displays a reward on the display of the device, the reward being based on the physical relationship between the device and the user that is monitored by the monitoring code segment

According to one aspect of the present disclosure, the monitoring code segment monitors a length of time that the information is visibly displayed on the display of the device to the user as the physical relationship between the device and the user.

According to another aspect of the present disclosure, the monitoring code segment monitors a number of times that the user contacts the display of the device while the information is displayed on the display as the physical relationship between the device and the user.

According to yet another aspect of the present disclosure, the monitoring code segment monitors the number of times that the user contacts an area of the display in which the information is displayed while the information is displayed on the display as the physical relationship between the device and the user.

According to still another aspect of the present disclosure, the monitoring code segment monitors a number of times that the user selects a predetermined input of the device while the information is displayed on the display as the physical relationship between the device and the user.

According to an additional aspect of the present disclosure, the at least one computer-readable medium further includes an entry receiving code segment that, when executed, receives an entry input to the device. In this regard, the monitoring code segment monitors a number of times that the entry receiving code segment receives the entry while the information is displayed on the display as the physical relationship between the device and the user.

According to another aspect of the present disclosure, the at least one computer-readable medium further includes a contact determining code segment that, when executed, determines whether the user one of contacts the display of the device and selects a predetermined input of the device within a predetermined period of time from when the information is displayed on the display. According to this aspect, the predetermined period of time is reset each time that the user one of contacts the display of the device and selects the predetermined input, and the monitoring code segment monitors a number of times that the interval monitoring code segment determines that the user one of contacts the display of the device and selects the predetermined input as the physical relationship between the device and the user.

According to yet another aspect of the present disclosure, the at least one computer-readable medium further includes a condition determining code segment that, when executed, determines whether the physical relationship that is monitored by the monitoring code segment satisfies a predetermined condition while the monitoring code segment monitors the physical relationship. In this regard, the reward displaying code segment is executed in response to the condition determining code segment determining that the physical relationship satisfies the predetermined condition.

According to still another aspect of the present disclosure, the reward is variable and the reward displaying code segment displays the reward in proportion to a degree by which the physical relationship exceeds the predetermined condition.

According to an additional aspect of the present disclosure, the at least one computer-readable medium further includes an identifying code receiving code segment that, when executed, receives an identifying code. The displaying code segment is executed in response to the identifying code receiving code segment receiving the identifying code and visibly displays the information in correspondence with the identifying code received by the identifying code receiving code segment.

According to another aspect of the present disclosure, the identifying code receiving code segment automatically receives the identifying code via a network when the device connects to the network.

According to yet another aspect of the present disclosure, the monitoring code segment monitors a duration that the device is connected to the network and usable by the user while the information is displayed on the display as the physical relationship between the device and the user.

According to still another aspect of the present disclosure, the at least one computer-readable medium further includes an information receiving code segment that, when executed, receives the information from a second user. The information is customizable and corresponds to the identifying code.

According to an additional aspect of the present disclosure, the at least one computer-readable medium further includes a reward receiving code segment that, when executed, receives the reward from the second user. The reward is customizable and corresponds to the identifying code and the information. The at least one computer-readable medium further includes a condition determining code segment that, when executed, determines whether the physical relationship that is monitored by the monitoring code segment satisfies a predetermined condition while the monitoring code segment monitors the physical relationship. In this regard, the reward displaying code segment is executed in response to the condition determining code segment determining that the physical relationship satisfies the predetermined condition.

According to another aspect of the present disclosure, the reward is variable and the reward displaying code segment displays the reward in proportion to a degree by which the physical relationship exceeds the predetermined condition.

According to yet another aspect of the present disclosure, the information is one of marketing information and advertising information, the user is a consumer, the second user is a retailer, and the device is an end user device including a processor and memory.

According to still another aspect of the present disclosure, the identifying code is manually input into the device by the user.

According to an additional aspect of the present disclosure, the identifying code receiving code segment receives the identifying code via the Internet in response to a website being accessed and the identifying code being requested.

According to another aspect of the present disclosure, the at least one computer-readable medium further includes a shopping list receiving code segment that, when executed, receives a shopping list of the user.

According to yet another aspect of the present disclosure, the information corresponds to the shopping list received by the shopping list receiving code segment.

According to still another aspect of the present disclosure, the reward corresponds to an item in the shopping list received by the shopping list receiving code segment.

According to an additional aspect of the present disclosure, the shopping list is downloaded to the device via a network.

According to another aspect of the present disclosure, the information is one of marketing information and advertising information.

According to yet another aspect of the present disclosure, the one of the marketing information and the advertising information includes static text.

According to still another aspect of the present disclosure, the one of the marketing information and the advertising information includes dynamic text.

According to an additional aspect of the present disclosure, the one of the marketing information and the advertising information includes flash photos.

According to another aspect of the present disclosure, the one of the marketing information and the advertising information includes streaming text.

According to yet another aspect of the present disclosure, the one of the marketing information and the advertising information includes a video.

According to another non-limiting embodiment of the present disclosure, a method provides an incentive to a user of a device to monitor information displayed on a display of the device. The method includes visibly displaying the information on the display of the device, monitoring a physical relationship between the device that includes the display that displays the information and the user while the information is visibly displayed on the display; and displaying a reward on the display of the device, the reward being based on the physical relationship between the device and the user that is monitored.

According to yet another even non-limiting embodiment of the present disclosure, a device includes provides an incentive to a user to monitor information. The device includes a body, a display fixed to the body, a graphics processor that visibly displays the information to the user on the display, and a central processor housed within the body that monitors a physical relationship between the device that includes the display that displays the information and the user while the graphics processor visibly displays the information on the display. The graphics processor further displays a reward on the display. The reward is based on the physical relationship between the device and the user that is monitored by the central processor.

According to one aspect of the present disclosure, the device further includes a holder that attaches to the body and that is adapted to attach to a shopping cart for visibly positioning the display to the user as the user controls the shopping cart.

According to still another non-limiting embodiment of the present disclosure, a system provides an incentive to a user of a device to monitor information displayed on a display of the device. The system includes a memory that stores the information in association with a reward. An information transmitter transmits the information to the device. The information is adapted to be displayed on the display of the device. A physical relationship monitoring instruction transmitter transmits a physical relationship monitoring instruction to the device. The physical relationship monitoring instruction is adapted to instruct the device to monitor a physical relationship between the device and the user while the information is displayed on the display of the device. A reward transmitter transmits the reward to the device. The reward is adapted to be displayed on the display of the device based on the physical relationship monitored between the device and the user.

According to one aspect of the present disclosure, the system further includes an identifying code receiver that receives an identifying code from the device. The information that is transmitted to the device corresponds to the identifying code received by the identifying code receiver.

According to another aspect of the present disclosure, the system further includes an information receiver that receives the information, a physical relationship condition, and the reward via a network. The information receiver stores the information, the physical relationship condition, and the reward in the memory. Each of the information, the physical relationship condition, and the reward are customizable and specified by a second user. The physical relationship monitoring instruction is adapted to instruct the device to monitor the physical relationship to determine whether the physical relationship satisfies the physical relationship condition. The reward is adapted to be displayed on the display of the device in response to the device determining that the physical relationship satisfies the physical relationship condition.

According to yet another aspect of the present disclosure, the reward is variable and adapted to be displayed in proportion to a degree by which the physical relationship exceeds the predetermined condition.

Other exemplary embodiments and advantages of the present invention may be ascertained by reviewing the present disclosure and the accompanying drawings. The above description should not be considered to limit the scope of the present invention.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 is a schematic of an exemplary system for providing an incentive to a user of a device to monitor information displayed on a display of the device, according to an embodiment of the present disclosure.

FIG. 2 is an enlarged schematic of the device shown in FIG. 1.

FIG. 3 is a schematic an exemplary holder for the device shown in FIG. 2 for attaching the device to a shopping cart.

FIG. 4 is a flow chart of an exemplary method for providing an incentive to a user of a device to monitor information displayed on a display of the device, according to an embodiment of the present disclosure.

### DETAILED DESCRIPTION

The present disclosure, through one or more of its various aspects, embodiments and/or specific features or sub-components, is thus intended to bring out one or more of the advantages as specifically noted below.

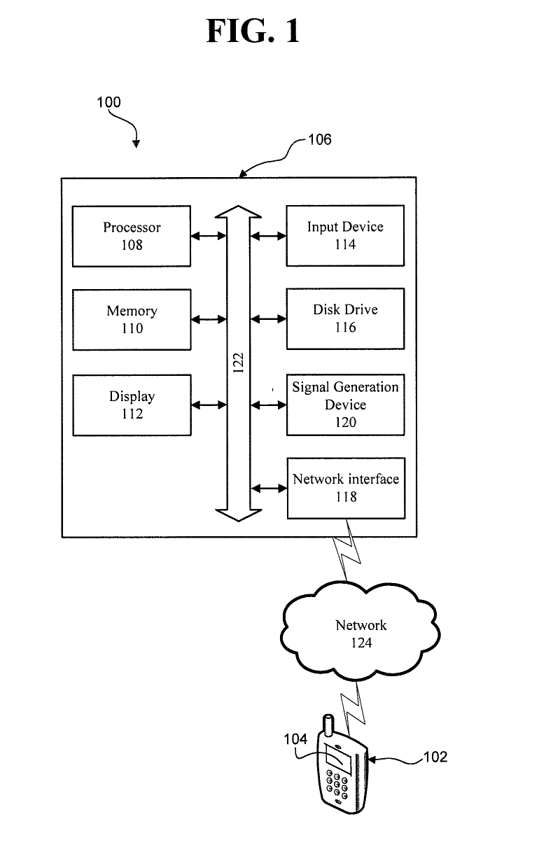

FIG. 1 is an illustrative embodiment of a system 100 in which an incentive is provided to a user of a device 102 to monitor information displayed on a device display 104 of the device 102. The system 100 is generally shown and may include a computer system 106, which is generally indicated. The computer system 106 may operate as a standalone device or may be connected to other systems or peripheral devices. For example, the computer system 106 may include, or be included within, any one or more computers, servers, systems, or communication networks.

The computer system 106 may operate in the capacity of a server or as a client user computer in a server-client user network environment. The computer system 106, or portions thereof, can also be implemented as, or incorporated into, various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 106 can be implemented using electronic devices that provide voice, video or data communication. Further, while a single computer system 106 is illustrated, the term “system” shall also be taken to include any collection of systems or sub-systems that individually or jointly execute a set, or multiple sets, of instructions to perform one or more functions.

As illustrated in FIG. 1, the computer system 106 may include a computer processor 108, such as, for example, a central processing unit (CPU), a graphics processing unit (GPU), or both. The computer system 106 may also include a computer memory 110. The computer memory 110 may include a static memory and/or a dynamic memory. The memory may further include a hard disk, random access memory, and/or a cache. Of course, those skilled in the art appreciate that the computer memory 110 may comprise any combination of known memories or a single storage.

As shown in FIG. 1, the computer system 106 may further include a computer display 104, such as a liquid crystal display (LCD), an organic light emitting diode (OLED), a flat panel display, a solid state display, or a cathode ray tube (CRT).

Additionally, the computer system 106 may include a computer input device 114, such as a keyboard, a remote control device having a wireless keypad, a microphone coupled to a speech recognition engine, a camera such as a video camera or still camera, a cursor control device. FIG. 1 shows the computer system as including a single input device 106. However, those skilled in the art appreciate that various embodiments of the computer system 106 may include multiple input devices. Moreover, those skilled in the art further appreciate that the above-listed input devices are merely meant to be exemplary and that the computer system 106 may include any additional, or alternative, input devices.

The computer system 106 may also include a disk drive 116 and a network interface 118. Furthermore, the computer system 106 may include any additional devices which are commonly known and understood as being within a computer system, such as, but not limited to, a signal generation device 120. The signal generation device 120 may be, but is not limited to, a speaker or a remote control.

Each of the components of the computer system 106 may be interconnected and communicate via a bus 122. As shown in FIG. 1, the components may each be interconnected and communicate via an internal bus. However, those skilled in the art appreciate that any of the components may also be connected via an expansion bus. Moreover, the bus 122 may enable communication via any standard or other specification commonly known and understood such as, but not limited to, peripheral component interconnect, peripheral component interconnect express, parallel ATA, serial ATA, etc.

Of course, those skilled in the art appreciate that the above-listed components of the computer system 106 are merely meant to be exemplary and are not intended to be exhaustive and/or inclusive. Furthermore, the examples of the components listed above are also meant to be exemplary and similarly are not meant to be exhaustive and/or inclusive.

As shown in FIG. 1, the computer system 106 may be in communication with the device 102 that includes the device display 104 via a network 124. The network 124 may be, but is not limited to, a local area network, a wide area network, the Internet, a telephony network, or any other network commonly known and understood in the art. Moreover, the network 124 is shown in FIG. 1 as a wireless network. However, those skilled in the art appreciate that the network 124 may also be a wired network.

The device 102 is shown in FIG. 1 as a cellular telephone. However, those skilled in the art appreciate that, in alternative embodiments of the present application, the device 102 may be a personal computer (PC), a tablet PC, a personal digital assistant (PDA), a mobile device, a palmtop computer, a laptop computer, a desktop computer, a communications device, a wireless telephone, a personal trusted device, a web appliance, or any other machine that includes a display and that is capable of executing a set of instructions (sequential or otherwise) that specify actions to be taken by that machine. Of course, those skilled in the art appreciate that the above-listed devices are merely exemplary devices and that the device 102 may be any additional device or apparatus commonly known and understood in the art without departing from the scope of the present application.

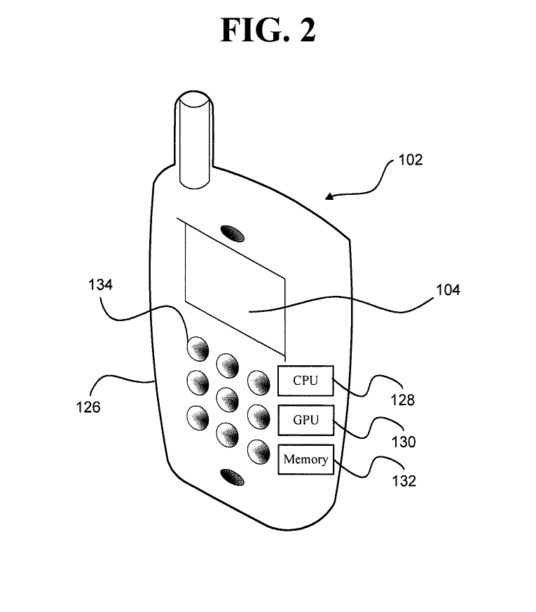

FIG. 2 shows an enlarged view of the device 102 shown in FIG. 1. As shown in FIGS. 1 and 2, the device 102 includes a device display 104. The device display 104 may be a liquid crystal display (LCD), an organic light emitting diode (OLED), a flat panel display, a solid state display, or a cathode ray tube (CRT). Of course, those skilled in the art appreciate that the device display 104 may also be additional types of displays commonly known and understood in the art such as, but not limited to, a thin film transistor (TFT) display, a thin film diode (TFD) display, or an active-matrix organic light-emitting diode (AMOLED). The device display 104 may be color or monochrome. Furthermore, the device display 104 may be a touchscreen display. The touchscreen display may be capacitive or resistive. Of course, those skilled in the art appreciate that the above-mentioned exampled are merely meant to be exemplary and that the device 102 may include additional types of displays.

The device 102 further includes a body 126 that houses a device processor. The device processor may comprise a central processing unit (CPU) 128, a graphics processing unit (GPU) 130, or both.

As shown in FIG. 2, the device 102 may further include a device memory 132. The device memory 132 may be internal memory, expandable memory, or both. Furthermore, the device memory 132 may include random access memory (RAM), a hard drive, or both. Moreover, the memory may be volatile memory, non-volatile memory, or any combination thereof. Of course, those skilled in the art appreciate that the above-mentioned types and forms of memory are merely meant to be exemplary and that device memory 132 may comprise any known type or form of memory or any combination thereof.

The device 102 may further include a device input 134. The device input 134 may be a mechanical input, such as, but not limited to, a mechanical keyboard, a scroll wheel, a button, a touch pad, or any combination thereof. However, the device input 134 may also be a digital input that is accepted via a touch screen, such as, but not limited to, a digital keyboard, a digital button, or any combination thereof. Of course, the device input 134 may also be any additional type of input that is commonly known and understood in the art, such as, but not limited to, a microphone. Moreover, those skilled in the art appreciate that the device input 134 may comprise any combination of known inputs.

In a particular embodiment of the present application, at least one computer-readable medium includes one or more sets of embedded instructions, e.g., software. The at least one computer-readable medium is a tangible, non-transitory article of manufacture, from which the sets of embedded instructions may be read. The instructions may embody one or more of the methods or logic as described herein.

In a particular embodiment, the at least one computer-readable medium may reside completely within the computer system 106. For example, the at least one computer-readable medium may be the computer memory 110, the disk drive 116, or a combination thereof. In this regard, the instructions may also reside completely within the computer system 106. The instructions may reside completely, or at least partially, within the computer memory 110, the disk drive 116, and/or within the computer processor 108 during execution by the computer system 106.

In an alternative embodiment of the present application, the at least one computer-readable medium may reside completely within the device 102. For example, the at least one computer-readable medium may be the device memory 132 as shown in FIG. 2. In this regard, the instructions may also reside completely within the device 102. The instructions may reside completely, or at least partially, within the device memory 132, the central processing unit (CPU) 128, and/or the graphics processing unit (GPU) 130 during execution by the device 102.

In an even further embodiment of the present application, the at least one computer-readable medium may comprise multiple media which reside in a combination of the computer system 106 and the device 102. For example, the at least one computer-readable medium may be any combination of the computer memory 110, the disk drive 116, and the device memory 132. In such an embodiment, the instructions may reside completely, or at least partially, within either the computer memory 110, the disk drive 116, the computer processor 108, the device memory 132, the central processing unit (CPU) 128, and/or the graphics processing unit (GPU) 130 during execution by the computer system 106 and the device 102.

In even further embodiments of the present application, the at least one computer-readable medium may be a standalone non-transitory computer readable medium or media, such as, but not limited to, a compact disc, digital video disc, flash drive, or combination thereof. The at least one computer-readable medium may further be transitory media, such as, but not limited to, signals or carrier waves, may embody one or more sets of instructions that implement one or more of the methods described herein. Of course, those skilled in the art appreciate that, in even further embodiments of the present application, the at least one computer readable-medium referenced herein may be any combination of computer-readable media residing in any combination of known devices and/or any combination of stand alone forms of computer-readable media. That is, the one or more sets of instructions embedded in the at least one computer readable-medium may reside in different computer-readable media located in different devises and/or in different stand alone computer-readable media.

According an embodiment of the present disclosure, the at least one computer-readable medium provides an incentive to a user of the device 102 to monitor information displayed on the display 104 of the device 102. The at least one computer-readable medium includes a displaying code segment that, when executed, visibly displays the information on the display 104 of the device 102. According to a non-limiting and exemplary embodiment of the present application, the information may comprise marketing information and/or advertising information. For example, the information may comprise a slogan or endorsement of a brand and/or an advertisement for a product. In this regard, the information is described hereinafter as marketing and/or advertising information. However, those skilled in the art appreciate that, in additional embodiments of the present application, the information may comprise additional and/or alternative types of information, such as, but not limited to, news headings, political endorsements, and survey questions.

The marketing and/or advertising information that is displayed on the display 104 of the device 102 may include static text, dynamic text, flashing photos, streaming text, videos, or any combination thereof. Of course, those skilled in the art appreciate that the marketing and/or advertising information may further include additional types of text and/or graphics that are well known in the art. Furthermore, the marketing and/or advertising information may further include audible data such as, but not limited to, sound effects, voices, music, or any combination thereof.

The marketing and/or advertising information may be constant, or the marketing and/or advertising information may be variable. For example, according to a non-limiting and exemplary embodiment of the present application, the marketing and/or advertising information may change every predetermined period of time. According to an alternative non-limiting and exemplary embodiment of the present application, the marketing and/or advertising information may change in response to a predetermined interaction by the user with the device 102, such as, but not limited to, the user touching or otherwise engaging the display 104 of the device 102 or the input 134 of the device 102. Of course, those skilled in the art appreciate that the above described embodiments of the present application are merely to be considered exemplary and that the marketing and/or advertising information may be configured to change in response to another event, such as, for example, the device 102 entering a standby mode. In this regard, the marketing and/or advertising information may change to prevent the device 102 from entering the standby mode.

The marketing and/or advertising information may be stored in the memory 132 of the device 102. Alternatively, the marketing and/or advertising information may be downloaded to the device 102 via the network 124. In this regard, the marketing and/or advertising information may be pushed to the device 102, or the marketing and/or advertising information may be requested by the device 102.

The at least one computer-readable medium further includes a monitoring code segment that, when executed, monitors a physical relationship between the device 102 that includes the display 104 that displays the marketing and/or advertising information and the user while the displaying code segment displays the information. The physical relationship between the device 102 and the user may comprise any interaction or combination of interactions between the user and the device. For example, the physical relationship may include the user touching or otherwise engaging the device 102. The use may directly touch or otherwise engage the device 102, and/or the user may indirectly touch or otherwise engage the device 102, such as, for example, via a stylus. In even further embodiments, the physical relationship may not require actual contact or engagement between the user and the device 102. For example, the user may issue a voice command to the device 102 and/or may simply move the device 102. In this regard, the physical relationship between the device 102 and the user is preferably any such relationship that focuses the user's attention on the device 102. As such, the user is attentive to the advertising and/or marketing information that is displayed on the device, thereby increasing the likely effectiveness of the advertising and/or marketing information on the user. Of course, those skilled in the art understand that the above-mentioned examples and advantages are merely meant to be exemplary and are not meant to be exhaustive or limiting.

According to an embodiment of the present application, the monitoring code segment may only monitor the physical relationship when the marketing and/or advertising information is actively displayed on the display 104, i.e., while the display 104 is lit up. In an alternative embodiment of the present application, the monitoring code segment may monitor the physical relationship when the marketing and/or advertising information is passively displayed on the display 104, i.e., while the display 104 is asleep and dimmed and/or off.

According to an embodiment of the present application, the monitoring code segment may monitor a length of time that the marketing and/or advertising information is visibly displayed on the display 104 of the device 102 to the user as the physical relationship between the device 102 and the user. That is, the monitoring code segment may monitor a length of time that the marketing and/or advertising information is displayed on the display 104 while the display 104 is lit. In this regard, the length of time may be monitored when the display 104 is fully lit, dimmed, or a combination thereof.

In an embodiment of the present application, the monitoring code segment may only monitor the length of time while the marketing and/or advertising information is visible to the user. In other words, the marketing and/or advertising information must not be blocked from the view of the user, such as, for example, by a browser. In an alternative embodiment of the present application, the monitoring code segment may monitor the length of time even when the marketing and/or advertising information is not visible to the user.

According to another embodiment of the present application, the monitoring code segment may monitor a number of times that the user contacts or otherwise engages the display 104 of the device 102 while the information is displayed on the display 104 as the physical relationship between the device 102 and the user. In this regard, the monitoring code segment may monitor the number of times that the user contacts or otherwise engages any part of the display 104. Alternatively, the monitoring code segment may monitor the number of times that the user contacts or otherwise engages an area of the display 104 in which the information is displayed. Furthermore, in additional embodiments of the present application, the monitoring code segment may monitor the number of times that the user contacts or otherwise engages one or more predetermined areas within the area of the display 104 in which the information is displayed. For example, the marketing and/or advertising information may be interactive and require the user to contact or otherwise engage specific portions thereof. Of course, those skilled in the art understand that the above-described embodiments are to be considered exemplary and that, in additional embodiments, the monitoring code segment monitors additional and/or alternative methods and/or manners in which the user contacts or otherwise engages the display 104.

The monitoring code segment may also monitor a number of times that the user selects a predetermined input of the device 102 while the information is displayed on the display 104 as the physical relationship between the device 102 and the user. In this regard, the predetermined input may be a specific key or button of the device input 134. Alternatively, the predetermined input may be a combination of keys or buttons of the device input 134, or any key or button of the device input 134. Those skilled in the art appreciate that the predetermined input may further be defined as the device input 134 itself if, for example, the device input 134 is a scroll wheel. Of course, the above described examples of the predetermined input are to be considered exemplary and are not in any way to be considered limiting.

In additional embodiments of the present application, the at least one computer-readable medium may include an entry receiving code segment that, when executed, receives an entry input to the device 102. The entry may be input by the user via the device input 134. According to such embodiments, the monitoring code segment may monitor a number of times that the entry receiving code segment receives the entry while the information is displayed on the display 104 as the physical relationship between the device 102 and the user. For example, according to a non-limiting and exemplary embodiment, the marketing and/or advertising information may require the user to answer questions and/or provide other data. In such a non-limiting and exemplary embodiment, the monitoring code segment may monitor the number of times that the user answers the questions and/or provides the other data. Of course, those skilled in the art appreciate that the above-described embodiments are to be considered exemplary and that additional and/or alternative entries may be input to the device 102.

In further embodiments of the present application, the at least one computer-readable medium may include a contact determining code segment that, when executed, determines whether the user contacts or otherwise engages the display 104 of the device 102 and/or selects the predetermined input of the device 102 within a predetermined period of time from when the information is displayed on the display 104. According to such embodiments, the predetermined period of time may be reset each time that the user contacts or otherwise engages the display 104 of the device 102 and/or selects the predetermined input of the device 102 within the predetermined period of time. In other words, according to such embodiments, the user must continually contact or otherwise engage the display 104 and/or the select the predetermined input at least once every predetermined time period so that the user's attention is maintained toward the device 102 and the marketing and/or advertising information displayed thereon. The monitoring code segment may monitor a number of times that the interval monitoring code segment determines that the user contacts or otherwise engages the display 104 of the device 102 and/or selects the predetermined input as the physical relationship between the device 102 and the user.

The at least one computer-readable medium further includes a reward displaying code segment that, when executed, displays a reward on the display 104 of the device 102. In an embodiment of the present application, the reward may be a monetary reward. In an alternative embodiment of the present application, the reward may be a coupon or a gift certificate for a discount and/or free merchandise. In this regard, the reward may include a scannable, downloadable or otherwise retrievable code including, but not limited to, a bar code or QR code. According to such an embodiment, if, for example, the user is in a retail store, the user may provide the reward to a cashier upon check-out in order to redeem the reward. In such an embodiment, if the user does not wish to presently redeem the reward, the reward may include an option through which the user is able to have the reward emailed to himself or herself. Alternatively, the reward may include an option through which the user is able to save the reward to the device memory 132. Of course, those skilled in the art appreciate that the above examples are to be merely considered exemplary and are not to be considered limiting. Furthermore, those skilled in the art further appreciate that additional and/or alternative rewards are further possible in additional embodiments of the present application. For example, additional rewards may include, but are not limited to, activity passes, ringtones, songs, videos, reward points, cellular minutes, and reduced and/or free cellular services.

In an embodiment of the present application, the reward may correspond to the marketing and/or advertising information that was, or is, displayed on the display 104 of the device 102. In an alternative embodiment, the reward may correspond to the location of the device 102. In further embodiments of the present application, the reward may randomly determined. Of course, those skilled in the art appreciate that the reward is not to be limited to the above examples. For example, in even further embodiments of the present application, the user may pre-register for rewards and the reward may be based on such pre-registration.

In an embodiment of the present application, the reward may be based on the physical relationship between the device 102 and the user that is monitored by the monitoring code segment. In this regard, the reward may be proportionally based upon the physical relationship.

In further embodiments of the present application, the at least one computer-readable medium may include a condition determining code segment that, when executed, determines whether the physical relationship that is monitored by the monitoring code segment satisfies a predetermined condition. According to such an embodiment, the reward displaying code segment may display the reward in response to the condition determining code segment determining that the physical relationship satisfies the predetermined condition. In this regard, the reward may be variable and proportionally based on a degree by which the physical relationship satisfies the predetermined condition. For example, in a non-limiting and exemplary embodiment of the present application, that reward may be a discount, and the amount of the discount may be based upon the degree by which the monitored physical relationship exceeds the predetermined condition. In the non-limiting and exemplary embodiment, a value of the reward may be linearly based upon the degree by which the monitored physical relationship exceeds the predetermined condition. Alternatively, the value of the reward may be exponentially based upon the degree by which the monitored physical relationship exceeds the predetermined condition. Of course, those of ordinary skill in the art understand that the above examples are merely exemplary and that, in additional embodiments, the reward may be determined based on additional criteria or independently of the predetermined condition.

In an embodiment of the present application, the at least one computer-readable medium may further include an identifying code receiving code segment that, when executed, receives an identifying code. In this regard, the displaying code segment may be executed in response to the identifying code receiving code segment receiving the identifying code. That is, the displaying code segment may display the marketing and/or advertising information in response to the identifying code receiving code segment receiving the identifying code. Moreover, the marketing and/or advertising information may correspond to the identifying code.

The identifying code receiving code segment may receive the identifying code upon the identifying code being manually input into the device 102 by the user. For example, the identifying code may be displayed at a point of store entrance via digital or paper signage, whereby the user may observe and enter the identifying code upon entering the store. Additionally, or alternatively, the identifying code receiving code segment may receive the identifying code via the Internet in response to a website being accessed. Of course, those skilled in the art appreciate that the identifying code may be received by the identifying code receiving code segment in additional and/or alternative manners.

For example, according to a non-limiting and exemplary embodiment of the present application, the user of the device 102 may be a consumer. In this regard, various retailers and/or merchants may register with the computer system 106 as shown in FIG. 1. The at least one computer-readable medium may include an information receiving code segment that, when executed, receives the marketing and/or advertising information from one of the retailers and/or merchants. The marketing and/or advertising information is preferably customizable and corresponds to an identifying code. As such, the retailers and/or merchants are able to provide custom marketing and/or advertising information to the user when the corresponding identifying code is received by the user's device 102.

According to an embodiment of the above-described non-limiting and exemplary embodiment of the present application, the identifying code receiving code segment may automatically receive the identifying code via the network 124 when the device 102 connects to a network. For example, if a retailer operates an establishment that includes a wireless or Bluetooth network, the identifying code may be broadcast over the network. As a result, when the user enters the retailer's establishment, the user's device 102 may automatically receive the identifying code that corresponds to the retailer. Thereafter, the custom marketing and/or advertising information that was provided by the retailer is displayed on the display 104 of the user's device 102. Accordingly, the retailer is able to provide custom marketing and/or advertising information to the user while the user is in the retailer's establishment.

According to the above-described embodiment, the identifying code which may be received automatically by the user's device 102 may be part of a program in which the user is required to opt-in. In this regard, the user may opt-in the program and specify particular retailers and/or establishments for which the user wishes to receive identifying codes. Thereafter, identifying codes for which the user “opted-in” may be automatuically received by the user's device. In alternative embodiments, the user may receive the codes for which the user “opted-in” via e-mail, text messages, voice messages, postal services, or any combination thereof. Of course, those skilled in the art appreciate that the user is not limited to “opting-in” to receive codes for a particular retailer or establishment. For example, the user may opt-in to receive identifying codes for particular types of stores, such as, for example, grocery stores and/or sporting good stores, or may opt-in to receive identifying codes which may be related to particular products, such as, for example, shoes and/or handbags. Of course, those skilled in the art appreciate that the above-mentioned examples are merely exemplary and are not meant to be exhaustive or limiting.

Moreover, according to the above-described non-limiting and exemplary embodiment of the present application, the at least one computer-readable medium may further include a reward receiving code segment that, when executed, receives a custom reward from the retailer. That is, the retailer may indicate a custom reward which the retailer desires to provide. The custom reward may be associated with the identifying code that is associated with the custom marketing and/or advertising information of the retailer. In this regard, the retailer may provide custom marketing and/or advertising information to a customer, and may further provide a custom reward to the customer to create an incentive for the customer to pay attention to the marketing and/or advertising information of the retailer.

Furthermore, also according to the above-described non-limiting and exemplary embodiment of the present application, the at least one computer-readable medium may further include a condition determining code segment that, when executed, determines whether the physical relationship that is monitored by the monitoring code segment satisfies a predetermined condition while the monitoring code segment monitors the physical relationship

In the above-described non-limiting and exemplary embodiment of the present application, those skilled in the art appreciate that certain code segments of the at least one computer-readable medium may be stored in a central server or computer, such as the computer system 106 as shown in FIG. 1, while additional code segments may be installed and/or downloaded to a consumer's end user device, such as the device 102. In this regard, in an exemplary embodiment, a retailer and/or merchant may register with the central server or computer to provide the custom marketing and/or advertising information and reward, while a customer may download an application from the central server or computer which includes the requisite code segments for monitoring the physical relationship between the customer and the end user device and for displaying the reward.

According to a further embodiment of the present application, the at least one computer-readable medium may include a shopping list receiving code segment that, when executed, receives a shopping list of the user. The shopping list may be a grocery list or any other list of items for which the user desires to shop. The shopping list may be manually input by the user or may be download to the device 102. Of course, those skilled in the art appreciate that the hopping list receiving code segment may receive the shopping list via additional and/or alternative means, such as, but not limited to, via a flash drive.

In the above embodiment, the marketing and/or advertising information may correspond to the shopping list received by the shopping list receiving code segment. For example, the marketing and/or advertising information may correspond to a specific item in the shopping list. Additionally, or alternatively, the marketing and/or advertising information may update to display marketing and/or advertising information for multiple items in the shopping list sequentially. The marketing and/or advertising information may be displayed simultaneously or alternately with the shopping list. The marketing and/or advertising information may scroll along or adjacent the bottom of the shopping list, or any other portion thereof. Additionally, or alternatively, the marketing and/or advertising material may be displayed within the shopping list proximate to the item to which it corresponds.

The reward may also correspond to an item in the shopping list. The reward may be displayed independently of the shopping list or within the shopping list proximate to the item to which it corresponds. Of course, those skilled in the art appreciate that, in alternative embodiments, the marketing and/or advertising information may not correspond to the shopping list and/or the reward may not correspond to the reward.

As shown in FIG. 1, the present disclosure also provides a system 106 for providing an incentive to a user of a device 102 to monitor information displayed on a display 104 of the device 102. Of course, those skilled in the art appreciate that the system 100 shown in FIG. 1 is merely an exemplary system and that additional systems are also provided within the scope and context of the present application.

The system 100 includes a memory, such as disk drive 116, that stores the information in association with a reward. An information transmitter, such as the network interface 118, transmits the information to the device 102 via the network 124. The information is adapted to be displayed on the display 104 of the device 102. A physical relationship monitoring instruction transmitter, such as the network interface 118, transmits a physical relationship monitoring instruction to the device 102 via the network 124. The physical relationship monitoring instruction is adapted to instruct the device 102 to monitor a physical relationship between the device 102 and the user while the information is displayed on the display 104 of the device 102. A reward transmitter, such as the network interface 118, transmits the reward to the device 102 via the network 124. The reward is adapted to be displayed on the display 104 of the device 102 based on the physical relationship monitored between the device 102 and the user.

According to an embodiment of the system 100, an identifying code receiver, such as the network interface 118, receives an identifying code from the device 102 via the network 124. In this regard, the information that is transmitted by the information transmitter corresponds to the identifying code that is received by the identifying code receiver.

According to another embodiment of the system 100, an information receiver, such as the network interface 118, receives the information, a physical relationship condition, and the reward via the network and stores the information, the physical relationship condition, and the reward in the memory. In this regard, each of the information, the physical relationship condition, and the reward are customizable and specified by a second user. Furthermore, the physical relationship monitoring instruction is adapted to instruct the device 102 to monitor the physical relationship to determine whether the physical relationship satisfies the physical relationship condition. Also, the reward is adapted to be displayed on the display 104 of the device 102 in response to the device 102 determining that the physical relationship satisfies the physical relationship condition. In an exemplary embodiment of the above described system 100, the reward is variable and proportional to a degree by which the physical relationship exceeds the predetermined condition. Of course, those skilled in the art appreciate that, in additional embodiments of the above described system 100, the additional and/or alternative rewards may be provided.

As shown in FIG. 2, the present disclosure additionally provides a device 102 that provides an incentive to a user to monitor information. Of course, those skilled in the art appreciate that the device 102 shown in FIG. 2 is merely an exemplary device and that additional devices are also provided within the scope and context of the present application.

According to an embodiment of the present application, the device 102 includes a body 126, a display 104 fixed to the body 126, a graphics processor 130 that visibly displays the information to the user on the display 104, and a central processor 128 that is housed within the body 126 and that monitors a physical relationship between the device 102 that includes the display 104 that displays the information and the user while the graphics processor 130 visibly displays the information on the display 104. The graphics processor 130 further displays a reward on the display 104. The reward is based on the physical relationship between the device 102 and the user that is monitored by the central processor 128.

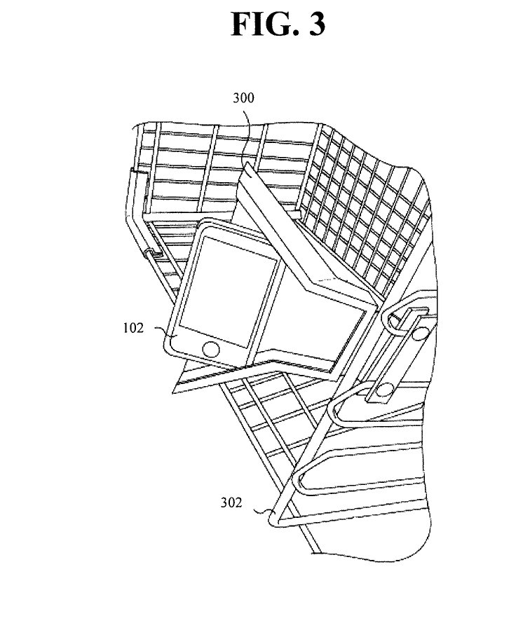

According to an embodiment of the present disclosure, the device 102 may further include a holder 300 that attaches to the body 126 and that is adapted to attach to a shopping cart 302 for visibly positioning the display 104 to the user as the user controls the shopping cart 302. Various embodiments of the holder 300 are disclosed in U.S. patent application Ser. No. 12/978,769, the disclosure of which, including the specification, drawings, and claims, is incorporated herein by reference in its entirety. An exemplary embodiment of the holder 300 is generally shown in FIG. 3. Those skilled in the art, however, appreciate that the holder 300 shown in FIG. 3 is merely an exemplary holder and that additional and/or alternative holders are also within the scope and context of the present application.

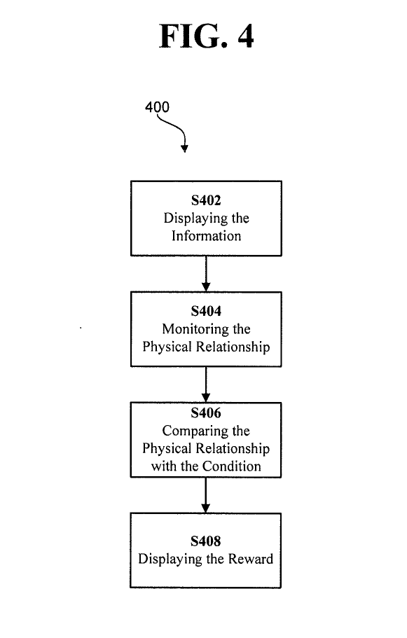

As shown in FIG. 4, the present disclosure additionally provides a method 400 for providing an incentive to a user of a device to monitor information displayed on a display of the device. The method includes visibly displaying the information on the display of the device at S402. A physical relationship between the device that includes the display that displays the information and the user is monitored while the information is visibly displayed on the display at S404. The monitored physical relationship is compared to a predetermined condition at S406. A reward is displayed on the display of the device at S408 in response to the monitored physical relationship satisfying the predetermined condition.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the methods described herein. Applications that may include the device and system of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. At least one non-transitory computer-readable medium for providing an incentive to a user of a device to monitor information displayed on a display of the device, the at least one non-transitory computer-readable medium comprising:
a displaying code segment that, when executed, visibly displays the information on the display of the device;
a monitoring code segment that, when executed, monitors a physical relationship between the device that includes the display that displays the information and the user while the displaying code segment displays the information; and
a reward displaying code segment that, when executed, displays a reward on the display of the device, the reward being based on the physical relationship between the device and the user that is monitored by the monitoring code segment.

2. The at least one non-transitory computer-readable medium as set forth in claim 1, wherein the monitoring code segment monitors a length of time that the information is visibly displayed on the display of the device to the user as the physical relationship between the device and the user.

3. The at least one non-transitory computer-readable medium as set forth in claim 1, wherein the monitoring code segment monitors a number of times that the user contacts the display of the device while the information is displayed on the display as the physical relationship between the device and the user.

4. The at least one non-transitory computer-readable medium as set forth in claim 3, wherein the monitoring code segment monitors the number of times that the user contacts an area of the display in which the information is displayed while the information is displayed on the display as the physical relationship between the device and the user.

5. The at least one non-transitory computer-readable medium as set forth in claim 1, wherein the monitoring code segment monitors a number of times that the user selects a predetermined input of the device while the information is displayed on the display as the physical relationship between the device and the user.

6. The at least one non-transitory computer-readable medium as set forth in claim 1, further comprising:
an entry receiving code segment that, when executed, receives an entry input to the device,
wherein the monitoring code segment monitors a number of times that the entry receiving code segment receives the entry while the information is displayed on the display as the physical relationship between the device and the user.

7. The at least one non-transitory computer-readable medium as set forth in claim 1, further comprising:
a contact determining code segment that, when executed, determines whether the user one of contacts the display of the device and selects a predetermined input of the device within a predetermined period of time from when the information is displayed on the display,
wherein the predetermined period of time is reset each time that the user one of contacts the display of the device and selects the predetermined input, and
the monitoring code segment monitors a number of times that the interval monitoring code segment determines that the user one of contacts the display of the device and selects the predetermined input as the physical relationship between the device and the user.

8. The at least one non-transitory computer-readable medium as set forth in claim 1, further comprising:
a condition determining code segment that, when executed, determines whether the physical relationship that is monitored by the monitoring code segment satisfies a predetermined condition while the monitoring code segment monitors the physical relationship,
wherein the reward displaying code segment is executed in response to the condition determining code segment determining that the physical relationship satisfies the predetermined condition.

9. The at least one non-transitory computer-readable medium as set forth in claim 8, wherein the reward is variable and the reward displaying code segment displays the reward in proportion to a degree by which the physical relationship exceeds the predetermined condition.

10. The at least one non-transitory computer-readable medium as set forth in claim 1, further comprising:
an identifying code receiving code segment that, when executed, receives an identifying code,
wherein the displaying code segment is executed in response to the identifying code receiving code segment receiving the identifying code and visibly displays the information in correspondence with the identifying code received by the identifying code receiving code segment.

11. The at least one non-transitory computer-readable medium as set forth in claim 10, wherein the identifying code receiving code segment automatically receives the identifying code via a network when the device connects to the network.

12. The at least one non-transitory computer-readable medium as set forth in claim 11, wherein the monitoring code segment monitors a duration that the device is connected to the network and usable by the user while the information is displayed on the display as the physical relationship between the device and the user.

13. The at least one non-transitory computer-readable medium as set forth in claim 10, further comprising:
an information receiving code segment that, when executed, receives the information from a second user, the information being customizable and corresponding to the identifying code.

14. The at least one non-transitory computer-readable medium as set forth in claim 13, further comprising:
a reward receiving code segment that, when executed, receives the reward from the second user, the reward being customizable and corresponding to the identifying code and the information;
a condition determining code segment that, when executed, determines whether the physical relationship that is monitored by the monitoring code segment satisfies a predetermined condition while the monitoring code segment monitors the physical relationship,
wherein the reward displaying code segment is executed in response to the condition determining code segment determining that the physical relationship satisfies the predetermined condition.

15. The at least one non-transitory computer-readable medium as set forth in claim 14, wherein the reward is variable and the reward displaying code segment displays the reward in proportion to a degree by which the physical relationship exceeds the predetermined condition.

16. The at least one non-transitory computer-readable medium as set forth in claim 13,
wherein the information is one of marketing information and advertising information,
wherein the user is a consumer,
wherein the second user is a retailer, and
wherein the device is an end user device including a processor and memory.

17. The at least one non-transitory computer-readable medium as set forth in claim 10, wherein the identifying code is manually input into the device by the user.

18. The at least one non-transitory computer-readable medium as set forth in claim 10, wherein the identifying code receiving code segment receives the identifying code via the Internet in response to a website being accessed and the identifying code being requested.

19. The at least one non-transitory computer-readable medium as set forth in claim 1, further comprising:
a shopping list receiving code segment that, when executed, receives a shopping list of the user.

20. The at least one non-transitory computer-readable medium as set forth in claim 19, wherein the information corresponds to at least one item in the shopping list received by the shopping list receiving code segment.

21. The at least one non-transitory computer-readable medium as set forth in claim 19, wherein the reward corresponds to at least one item in the shopping list received by the shopping list receiving code segment.

22. The at least one non-transitory computer-readable medium as set forth in claim 19, wherein the shopping list is downloaded to the device via a network.

23. The at least one non-transitory computer-readable medium as set forth in claim 1, wherein the information is one of marketing information and advertising information.

24. The at least one non-transitory computer-readable medium as set forth in claim 23, wherein the one of the marketing information and the advertising information includes static text.

25. The at least one non-transitory computer-readable medium as set forth in claim 23, wherein the one of the marketing information and the advertising information includes dynamic text.

26. The at least one non-transitory computer-readable medium as set forth in claim 23, wherein the one of the marketing information and the advertising information includes flash photos.

27. The at least one non-transitory computer-readable medium as set forth in claim 23, wherein the one of the marketing information and the advertising information includes streaming text.

28. The at least one non-transitory computer-readable medium as set forth in claim 23, wherein the one of the marketing information and the advertising information includes a video.

29. A method for providing an incentive to a user of a device to monitor information displayed on a display of the device, the method comprising:
visibly displaying the information on the display of the device;
monitoring a physical relationship between the device that includes the display that displays the information and the user while the information is visibly displayed on the display; and
displaying a reward on the display of the device, the reward being based on the physical relationship between the device and the user that is monitored.

30. A device that provides an incentive to a user to monitor information, the device comprising:
a body;
a display fixed to the body;
a graphics processor that visibly displays the information to the user on the display; and
a central processor housed within the body that monitors a physical relationship between the device that includes the display that displays the information and the user while the graphics processor visibly displays the information on the display,
wherein the graphics processor further displays a reward on the display, the reward being based on the physical relationship between the device and the user that is monitored by the central processor.

31. The device as set forth in claim 30, further comprising:
a holder that attaches to the body and that is adapted to attach to a shopping cart for visibly positioning the display to the user as the user controls the shopping cart.

32. A system for providing an incentive to a user of a device to monitor information displayed on a display of the device, the system comprising:
a memory that stores the information in association with a reward;
an information transmitter that transmits the information to the device, the information adapted to be displayed on the display of the device;
a physical relationship monitoring instruction transmitter that transmits a physical relationship monitoring instruction to the device, the physical relationship monitoring instruction adapted to instruct the device to monitor a physical relationship between the device and the user while the information is displayed on the display of the device; and
a reward transmitter that transmits the reward to the device, the reward adapted to be displayed on the display of the device based on the physical relationship monitored between the device and the user.

33. The system as set forth in claim 32, further comprising:
an identifying code receiver that receives an identifying code from the device,
wherein the information corresponds to the identifying code received by the identifying code receiver.

34. The system as set forth in claim 32, further comprising:
an information receiver that receives the information, a physical relationship condition, and the reward via a network and stores the information, the physical relationship condition, and the reward in the memory, each of the information, the physical relationship condition, and the reward being customizable and specified by a second user,
wherein the physical relationship monitoring instruction is adapted to instruct the device to monitor the physical relationship to determine whether the physical relationship satisfies the physical relationship condition, and
wherein the reward is adapted to be displayed on the display of the device in response to the device determining that the physical relationship satisfies the physical relationship condition.

35. The system as set forth in claim 34, wherein the reward is variable and adapted to be displayed in proportion to a degree by which the physical relationship exceeds the predetermined condition.
